(19) United States
(12) Patent Application Publication
(10) Pub. No.: US 2024/0427820 A1
(43) Pub. Date: Dec. 26, 2024

(54) Automated Remote Music Identification and Publishing System and Method

(71) Applicant: Deepen Shah

(72) Inventor: Deepen Shah

(21) Appl. No.: 18/338,620

(22) Filed: Jun. 21, 2023

Related U.S. Application Data
(63) Continuation-in-part of application No. 17/847,029, filed on Jun. 22, 2022.

(51) Int. Cl. G06F 16/687; G06F 16/215; G06F 16/638

(52) U.S. Cl. CPC G06F 16/687; G06F 16/215; G06F 16/638

(57) ABSTRACT

A song location publication module configured to receive sound interval data representing a time length of a portion of a music stream at a venue and a physical location corresponding to the venue. The module includes a location database, a sample interval match unit, a venue location match unit and a client graphical user interface. The location database configured to store the physical location of the venue. The sample interval match unit configured to match the sound interval data to a known musical composition and a music title. The venue location match unit configured to generate a data set including the title matched with the venue or the physical location of the venue. The client graphical user interface configured to display the data set.

### RELATED APPLICATIONS

This is a continuation in part of application Ser. No. 17/847,029 filed Jun. 22, 2022. The disclosure of the prior application is hereby incorporated by reference herein in its entirety.

### BACKGROUND OF THE INVENTION

### 1. Field of the Invention

The present invention relates to a system for identifying music played in venues in real time and providing the currently playing song list to system clients via a graphical user interface (“GUI”). More specifically, the system may receive intervals of sound data transmitted from a device at a venue, and the system may match song data corresponding to the sound data. The device at a venue would be physically installed at a fixed location, and the device is customizable in terms of the length of the audio pinging time interval from the venue or the length of the audio time interval is customizable automatically by the system or from an interface controlled by the system. Users located at the venue may also crowd source information and share it, via the system, if running a system application (“App”) on their mobile cell phones. Finally, the system may provide, via computer networks, the matching song data to the GUI of system clients.

### 2. Description of the Related Art

Conventional Apps allow users to utilize personal computing devices such as smart phones, tablets or computers to identify songs in the user's surroundings. These Apps depend on user control and interface for operation. For example, the Apps require a user to decide when a song needs to be identified and then, the user must activate the App to allow the App to identify the song. Also, the user determines where their computing device is located so the App may only identify music at the user's location.

While the Apps offer some ability to identify surrounding music, the Apps also have many drawbacks. First, the App is on the user's device. Therefore, the Apps are limited to identifying song data in the precise location of the user or user device. For example, the user may not be located in a venue playing music and/or may not be in an acoustically desirable location for recording. Second, the App is only operable when the user determines song identification is needed. The user may listen to music at a venue for 4 hours and only activate the App once or twice to sample and match a song or maybe not at all. Third, the user determines the position of their device which may be covered in a pocket or bag and otherwise not positioned well for the device microphone to record. In short, song identification using the Apps is limited to the preferences and location of the user and not configured to provide song information to anyone but the user.

The Apps are also limited to providing song matching information to the single user that is requesting the match. The Apps fail to provide the user with real time data of any music being played at different venues. Therefore, the user does not know if another venue might have more enjoyable musical entertainment.

Further, the Apps provide data to only the user requesting the song data for one purpose which is merely song identification. The App does not provide any information to any other types of users such as artists, record labels, the venue, advertisers, etc. Further, the App does not tell any users where the music is being played or keep a real time and historical database of songs being played in various venues across town and the world.

Therefore, there is a need for a system that may match songs being played at various venues and broadcast the song data being played at different venues to plurality of different types of users in a plurality of locations both within the venue and may not be located within the venue.

### BRIEF SUMMARY OF THE INVENTION

Identifying songs being played at different venues is beneficial for many reasons such as copyright enforcement, popularity ranking and entertainment marketing and enjoyment. Played song data may be acquired and published, in real time, on the world wide web and/or other computer networks. The identification of music or audio acoustic information may also include an attempt to recognize live performances where there is no match against commercially recognized databases. For example, if the audio/songs within a venue are being played via a DJ, the system will attempt to recognize it via commercially viable databases. If the venue has a live band playing music, the system will attempt to categorize the audio by parsing instruments, beats per minute (“BPM”), and other acoustic information to determine the genre and other attributes that users may want to know. Artists with access to this song data would be able to track musical and real-time audio information pertaining to music data corresponding to a venue.

Therefore, artists, musicians and record labels would be able to track their music worldwide for copyright compliance and popularity purposes. Also, current genre of music and song titles being played in different entertainment establishments may be published on the internet and/or sent to smart phone applications. This would allow people the option to choose, in real time, which venue they would like to visit to experience different music or dance.

In some aspects, the techniques described herein relate to a music location publication system including: at least one computer processor or plurality of computer processors and non-transitory memory; a song location publication module executable by said at least one computer processor or said plurality of computer processors, the song location publication module configured to receive sound interval data representing a time length of a portion of a music stream at a venue and a physical location corresponding to the venue, the song location publication module including a location database in the non-transitory memory, the location database configured to store the physical location of the venue, a sample interval match unit executable by said at least one computer processor or said plurality of computer processors, the sample interval match unit configured to match the sound interval data to a known musical composition and a title, and a venue location match unit executable by said at least one computer processor or said plurality of computer processors, the venue location match unit configured to generate a data set including the title matched with the venue or the physical location of the venue; and at least one client graphical user interface connected to said at least one computer processor or said plurality of computer processors, the at least one client graphical user interface configured to display the data set.

In some aspects, the techniques described herein relate to a system, wherein the at least one client graphical user interface is located at the venue.

In some aspects, the techniques described herein relate to a system, wherein the at least one client graphical user interface is located at a remote location outside of the venue.

In some aspects, the techniques described herein relate to a system, wherein the at least one client graphical user interface is a plurality of client graphical user interfaces including a first client graphical user interface positioned at the venue and a second client graphical user interface positioned at a remote location outside the venue.

In some aspects, the techniques described herein relate to a system, further including: a match database in the non-transitory memory, the match database including the data set of the title matched with the venue or the physical location of the venue.

In some aspects, the techniques described herein relate to a system, further including: at least one user graphical user interface connected to said at least one computer processor or said plurality of computer processors, the at least one user graphical user interface configured to receive search instructions for a first title and display a first venue or a first location where the first title was played.

In some aspects, the techniques described herein relate to a system, wherein the song location publication module further includes: a data quality unit executable by said at least one computer processor or said plurality of computer processors, the data quality unit configured to determine a quality level corresponding to the sound interval data.

In some aspects, the techniques described herein relate to a system, further including: a sound recording device at the venue, the sound recording device configured to transmit the sound interval data to the song location publication module; and a device graphical user interface connected to said at least one computer processor or said plurality of computer processors, the device graphical user interface configured to display information corresponding to the sound recording device and the sound interval data.

In some aspects, the techniques described herein relate to a system, further including: a device controller executable by said at least one computer processor or said plurality of computer processors, the device controller configured to receive, from the data quality unit, the quality level of the sound interval data and display, on the device graphical user interface, the quality level of the sound interval data.

In some aspects, the techniques described herein relate to a system, further including: a device controller executable by said at least one computer processor or said plurality of computer processors, the device controller configured to receive the quality level from the data quality unit and based on the quality level, instruct the sound recording device to change the time length of recording the sound interval data.

In some aspects, the techniques described herein relate to a system, wherein the sound recording device includes a first microphone and a second microphone and the sound recording device is recording the sound interval data with the first microphone, further including: a device controller executable by said at least one computer processor or said plurality of computer processors, the device controller configured to receive the quality level from the data quality unit and when the quality level is insufficient, instruct the sound recording device to use the second microphone to record the sound interval data.

In some aspects, the techniques described herein relate to a system, further including: a sound recording device at the venue, the sound recording device configured to transmit the sound interval data to the song location publication module; and a device controller executable by said at least one computer processor or said plurality of computer processors, the device controller configured to instruct the sound recording device to transmit the sound interval data, for the time length, to the song location publication module and the device controller configured to instruct the sound recording device not to transmit the sound interval data to the song location publication module for a another time length such that the time length and another time length continually repeat in an alternating pattern.

In some aspects, the techniques described herein relate to a system, further including: a sample interval data receiver executable by said at least one computer processor or said plurality of computer processors, the sample interval data receiver configured to receive the sound interval data for the time length, and the sample interval data receiver configured, for an another time length, not to receive any sound data from the music stream such that the time length and the another time length continually repeat.

In some aspects, the techniques described herein relate to a method of publishing songs played at a venue, the method including steps of: providing at least one computer processor or plurality of computer processors including a communication interface and non-transitory memory; receiving, via the communication interface, sound interval data from at least one physical address, the sound interval data having a time length corresponding to a portion of an audible music stream; storing a venue location database in the non-transitory memory, the venue location database including a plurality of physical addresses from which the sound interval data is received; using a song match publication module that is executable on said at least one computer processor or said plurality of computer processors to match the sound interval data to a known music composition and identify a corresponding physical address of the plurality of physical addresses from which the sound interval data was received; and displaying on at least one client graphical user interface connected, via the communication interface, to the song match publication module, the known music composition and the corresponding physical address of the plurality of physical addresses.

In some aspects, the techniques described herein relate to a method, wherein the step of receiving, via the communication interface, the sound interval data from the at least one physical address further includes steps of: receiving a data packet including the sound interval data and the corresponding physical address or a location tag from which the data packet was received.

In some aspects, the techniques described herein relate to a method, wherein the step of storing the venue location database in the non-transitory memory, further includes steps of: storing a plurality of location tags in the venue location database, wherein each location tag of the plurality of location tags corresponds to one physical address of the plurality of physical addresses stored in the venue location database.

In some aspects, the techniques described herein relate to a method, further including the steps of: matching the location tag of the data packet with the one physical address of the plurality of physical addresses.

In some aspects, the techniques described herein relate to a method, further including the steps of: providing a device controller that is executable on said at least one computer processor or said plurality of computer processors, the device controller in communication with a sound interval recording device at the venue from which the sound interval data is received; and sending instructions from the device controller to the sound interval recording device to increase or decrease the time length of recording the sound interval data.

In some aspects, the techniques described herein relate to a method, further including steps of: detecting, through use of the song match publication module, a quality of the sound interval data; and instructing, based on the quality of the sound interval data, the sound interval recording device to increase or decrease the time length of recording the sound interval data.

In some aspects, the techniques described herein relate to a method, further including the steps of: detecting, through use of the song match publication module, a quality of the sound interval data as being insufficient; and displaying on a user graphical interface corresponding to a sound recording device from which the sound interval data was received, a notification of insufficient signal quality.

In some aspects, the techniques described herein relate to a method, further including the steps of: detecting, through use of the song match publication module, a quality of the sound interval data as insufficient; and displaying on a user graphical interface corresponding to a sound recording device from which the sound interval data was received, a notification of insufficient signal quality.

In some aspects, the techniques described herein relate to a method, further including a step of: providing sound recording device connected, via the communications interface, to the song match publication module.

In some aspects, the techniques described herein relate to a method, further including the step of: providing a user graphical interface in communication with the sound recording device and the song match publication module; and receiving, via the user graphical interface, the physical address of the venue from which the sound interval data is received.

In some aspects, the techniques described herein relate to a non-transitory machine-readable medium containing a set of executable instructions to facilitate a method of publishing songs played at a venue, the method including steps of: receiving sound interval data from at least one venue, the sound interval data having a time length corresponding to a portion of an audible music stream; storing a venue location database in a non-transitory memory such that the venue location database includes a plurality of venues from which the sound interval data is received and a plurality of venue physical addresses, wherein each venue of the plurality of venues is matched with a corresponding venue physical address of the plurality of venue physical addresses; using a song match publication module to match the sound interval data to a known music composition and identify the venue physical address of plurality the venue physical addresses from which the sound interval data was received; and displaying on at least one client graphical user interface connected, via a communication interface, to the song match publication module, the known music composition and physical location address of the venue from which the sound interval data was received.

### BRIEF DESCRIPTION OF THE SEVERAL VIEWS OF THE DRAWINGS

The foregoing summary, as well as the detailed description of the preferred embodiments of the present invention, will be better understood when read in conjunction with the appended drawings. For the purpose of illustrating the invention, there is shown in the drawings, which are diagrammatic, embodiments that are presently preferred. It should be understood, however, that the present invention is not limited to the precise arrangements and instrumentalities shown. In the drawings:

FIG. 1 is a schematic of a song location tracking and publishing system, according to this disclosure;

FIG. 2 depicts a song matching and location tracking system, according to this disclosure, utilized with the song location tracking and publishing system of FIG. 1;

FIG. 3 is a schematic of a data packet, according to this disclosure, utilized with the song location tracking and publishing system of FIG. 1;

FIG. 4 is a registration GUI, according to this disclosure, for registering a device located in a venue with the song matching and location tracking system of FIG. 2;

FIG. 5 is a match GUI, according to this disclosure, generated by the song matching and location tracking system of FIG. 2;

FIG. 6 depicts a historical GUI, according to this disclosure, generated by the song matching and location tracking system of FIG. 2;

FIG. 7 depicts a flow diagram of an embodiment of a method, according to this disclosure, of operating song matching and location tracking system of FIG. 2; and

FIG. 8 is an exemplary schematic of the computer or network system that may be implemented with computer readable code, according to the present disclosure.

### DETAILED DESCRIPTION OF THE INVENTION

While the present invention is described herein with reference to illustrative embodiments for particular applications it should be understood that the invention is not limited thereto. Those skilled in the art with access to the teachings provided herein will recognize additional modifications, applications and embodiments within the scope thereof and additional fields in which the invention would be of significant utility.

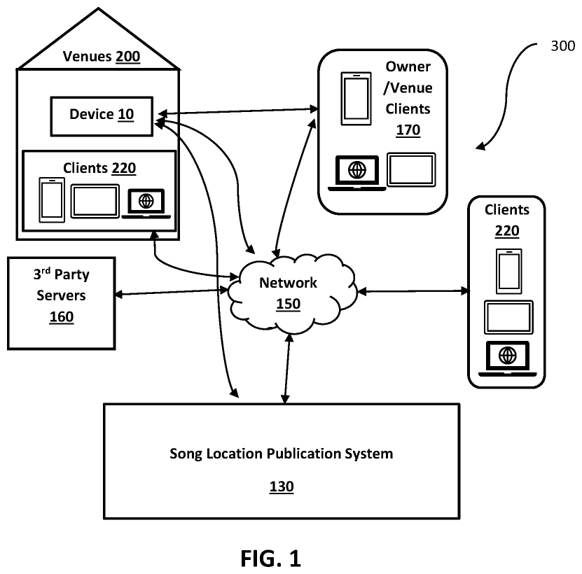

An overview of a song/music identification, location tracking and publishing system 300 is shown in FIG. 1. The system 300 may include at least one sound and location recording device 10 positioned at one or more venues 200 in communication with a song location publication system 130. The song location publication system 130 may be configured to provide server-side functionality, via network 150, to one or more devices 10, devices 170, 220 and third parties 160. The device 10 may relay to the system 130 data corresponding to the venue 200 where the device 10 positioned as well as sample interval data 30 corresponding to songs/music being played at a venue 200. System 130 may publish the song titles corresponding to the sample interval data 30 with the source venue 200 to various devices 170, 220 and third parties 160. Both devices 10 and system 130 may, in real-time, collect, match and publish song data including song titles, lyrics, performer, etc. It is noted that devices 170, 220 and third parties 160 may be located within the various venues 200, outside and/or remote from the venues 200.

The venues 200 are the sources of audio entertainment experiences such as a restaurant or bar with live or recorded music and concert halls, etc. The audio entertainment experience includes musical entertainment, comedy and/or play, etc. Musical entertainment is used herein as an example of audio entertainment in the system 300 of this disclosure, but it is envisioned that the system 300 may be applicable to all forms of audio entertainment. Also, each venue 200 may include one or more sources for entertainment. For example, bars and theaters may have multiple stages at different locations and performances may occur simultaneously.

The device 10 may be positioned at a venue 200 in a suitable position for recording audible musical entertainment stream which may be live, recorded or DJ mixed, etc. Further, if a venue 200 includes more than one area devoted to musical entertainment, there may be more than one device 10 at that venue 200 with each device 10 associated with a different source of entertainment. Device 10 may record sample interval data 30 corresponding to the musical entertainment and transmit the sample interval data 30 to system 130. The operation of the device 10 is described in U.S. patent Ser. No. 17/847,029 entitled “Automated Remote Music Identification Device and System” which is incorporated by reference herein in its entirety.

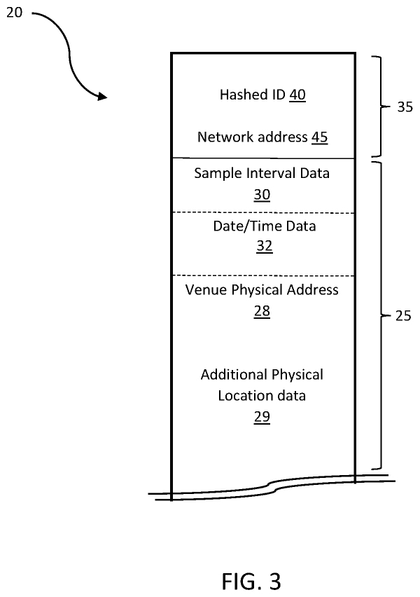

The device 10 may send, in real-time, the sample interval data 30 to system 130 with device identification data corresponding to the specific device 10 that recorded the sample interval data 30. For example, the data packet 20, as shown in FIG. 3 may include a body 25 and header 35. The body 25 may include the sample interval data 30 and the venue physical address 28 of venue 200 at which the device 10 is located and if multiple music source areas exist at the venue 200, additional physical location data 29 corresponding to the physical locations of additional sources. The header 35 includes a hashed ID or ID value 40 and may also include device network address data 45 which as is known in the art is different than the physical address 28. For example, physical address 28 may be a physical earth location such as longitude and latitude coordinates, Global Positioning System (GPS) coordinates, a street address, floor or room of a venue 200, or any combination thereof, etc. The hashed ID 40 is a unique identifier that the API server 450 generates after the device 10 is registered at the venue 200. For example when the device 10 is initialized at the venue 200, it will be initialized with the information mentioned above (earth location such as longitude and latitude coordinates, Global Positioning System (GPS) coordinates, a street address, floor or room) and then the API server will return a hashed ID or ID value 40 that the on premises device 10 will save and then pass back to system 130 in the header 35. The hashed ID or ID value 40 would be different than a network address relates to the position of the device 10 within the system 300 rather than the earth.

The device 10 may include one of more microphone(s) that are enabled to automatically record sound data at regular or irregular sample intervals continually or for predetermined time periods of equal or differing length. The length and type of the time periods and intervals may be preset during manufacture of the device 10 and/or provided to the device 10 via the device 10 owner's (e.g., individual or venue that purchased the device) computerized devices 170 (e.g., smart phone, computer and/or tablet) and system 130. That is, the predetermined time period of the sample interval may be changed by the devices 170 or system 130.

The interval time lengths may be less than the length of an entire song or performance but continually recorded and sent to system 130. For another time length in between the sample intervals, device 10 does not send audio data to the system 130. For example, the system 130 may receive sample interval data 30 corresponding to 5 seconds of audio from a device 10 at a venue 200. Then, system 130 may not receive sample interval data 30 from that device for another 30 seconds. However, system 130 will continually receive the sample interval data 30 in this repetitive 5/30 second pattern unless system 130 or device owner instructs the device 10 to change the recording intervals time lengths. In other words, the sample interval corresponding to the time length and a non-recording interval corresponding to another time length continually repeat in an alternating, consecutive pattern. It is noted that the time length and another time length may be equivalent or different.

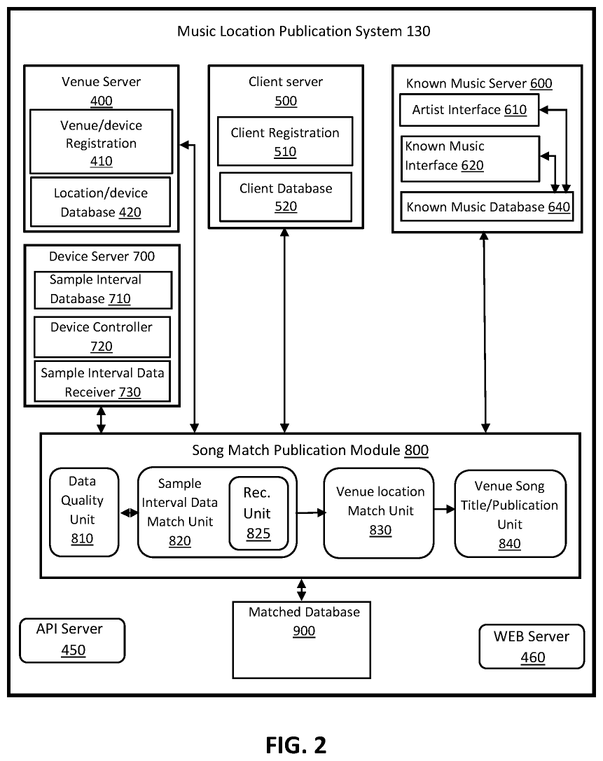

System 130 is configured to receive the data packet 20 from device(s) 10, match the sample interval data 30 to known song data and communicate, in real-time, the corresponding matched song information (e.g., song title, artist, venue, venue location and time of play) to client devices 220, owner and venue devices 10 as well as 3^{rd} party 160 clients. As shown in FIG. 2, system 130 includes a venue server 400, application server interface (API) 450, web server 460, client server 500, known music server 600, device server 700, match distribution module 800, and music/song title and venue database 900. The API and web servers 450, 460 provide for two-way communication between one or more devices 10, system 130, 3^{rd} party 160 servers, artists and known repositories. While device 10 and system 130 may both be located at the venue 200, in most situations, the system 130 may be positioned remotely from the device(s) 10. Therefore, communication between device(s) 10 and system 130 may be enabled through the API and/or web servers 450, 460 and different types of networks such as wired, cellular, Wi-Fi or any combination thereof.

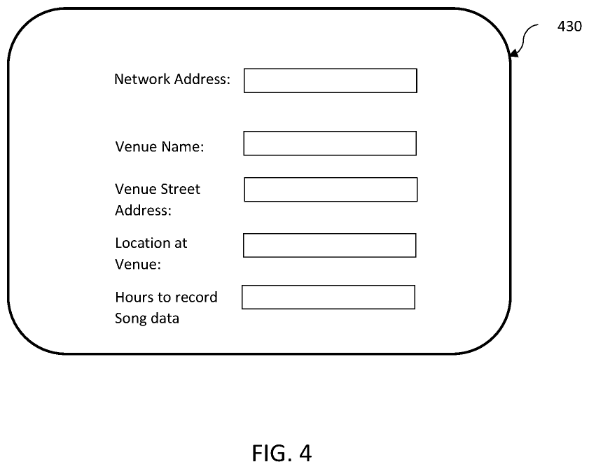

The venue server 400 may include a venue registration unit 410 and venue/database 420. The venue registration unit 410 provides a registration GUI 430 (FIG. 4) for the owner of a device 10 or other appropriate venue personnel to register device 10 with system 130. The registration GUI 430 is accessible using a venue/owner device 170 which may be computerized devices (e.g., smart phone or computer). First, devices 170 connect to the service set identifier (“SSID”)/Broadcast ID or access point name of the device 10. Next, device 170 visits a website URL (i.e., https://192.168.1.1XX) to locally connect to the device 10 and then be presented with a registration GUI 430 (FIG. 4) through which system 130 may receive, from the user, relevant venue information including the name, address and location within the venue 200. The network address of device 10, within system 300, may be automatically determined by the venue server 400. Also, the venue server 400 automatically creates a unique hash ID for the device. Essentially, when the device is initialized in the venue 200, the device 10 will emit a Wi-Fi signal to be configured, but the device 10 also needs two Wi-Fi cards or one Wi-Fi card and one cellular connection. The dual communication avenues allow the user that is configuring it to access the device 10 separately and/or directly. Once configured the device 10 may be locked onto the Wi-Fi system of the venue 200 and then be utilized there.

The venue/database 420 stores all the registered devices 10 and corresponding venue 200 information gathered by the GUI 430. For example, venue/database 420 stores each the hashed ID 40 assigned to each device 10 matched with each network address 45, venue name and venue physical address 28 as well as the additional physical location data 29 of the device 10, if applicable.

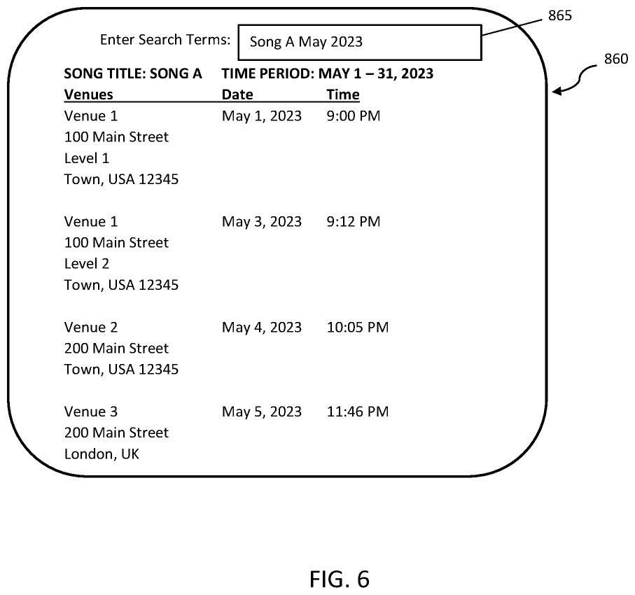

The client server 500 may include client registration unit 510 and client database 520. The client registration unit 510 allows the various users of the system 130 to register, via client devices 220, for access to services of system 130 including notifications (i.e., email, texts, notifications, etc.) of real time songs (live and/or recorded) performances at various venues 200 and/or physical addresses 28. Unit 510 provides at least one client GUI on at least one client device 220 which may be a computer, tablet, smart phone, etc. The client GUI allows client device 220 to be registered with the client server 500. For example, a client device 220 may access a client server website or application which displays a client GUI including a request for client and/or user data such as cell phone number and/or email address and the geographic area about which the client would like to receive the song and location data. Further, Unit 510, via the client GUI, establishes logon credentials for each client and user including the user's screen name and password. In addition to receiving messages about real time song data, users may access the data by logging, using established credentials, onto a match GUI 860 (FIG. 6) provided by the match publication module 800.

Server 500 stores all client data gathered by unit 510 and the client GUI into client database 520. For example, the client database includes user data such as logon credentials, user geographic location, user preferences for location radius for song/venue locations, user email address, cell phone number and any network address assigned to client device 220.

The known music server 600 is configured to provide access to music data files of known musical compositions including song, lyrics, title, artist, video and musical data files. To assure access to a comprehensive number of data files, server 600 includes an artist interface 610, known music interface 620 and known music database 640. The artist interface 610 provides an artist GUI through which system 130 may receive music data files directly from artists and/or their representatives. The artist GUI is particularly useful for songs that are not available in known music databases accessible via the internet. Examples of songs that may be uploaded are different artist's versions of known music as well as unpublished music data. The known music interface 620 allows system 130 to access to large music data repositories via the web or other connections.

The known music database 630 includes data files of known music. For example, database 630 may store any music that has been uploaded by the artists via the artist interface 610. Also, the known music database 630 may store any song data obtained or accessed via the known music interface 620 that has been used in the song matching process.

The device server 700 is configured to interface with at least one device 10, but there will most likely be multiple device(s) 10 in use with system 300 with multiple devices 10 and multiple corresponding venues 200. Server 700 may include a sample interval database 710, a device controller 720 and a sample interval data receiver 730. The sample interval data receiver 730 receives all data packets 20, including the sample interval data 30 and hash ID 40. The data packets 20 may also include the venue physical address 28 and additional location data 29. Server 700 then stores all the received data packet 20 in sample interval database 710.

The device controller 720 receives instructions from the match publication module 800 as to the operation of the device(s) 10. For example, if module 800 determines the quality of the interval sample data 30 is poor or insufficient for use in song identification, module 800 will relay this information to controller 720 and the device controller 720 will communicate to the corresponding device 10 to increase the interval sample time length. Additionally, the device controller 720 may direct the corresponding device 10 to change the microphone(s), associated with the device 10, that are being used to record the sample interval data 30. Further, the device controller 720 may communicate, via the client server 500, to a GUI on devices 170 that the recording quality level of the device 10 is poor and the location should be changed.

Another solution to poor sample quality includes changing the characteristics of recording performed by the device. The controller 720 may ask device 10 to adjust the bitrate, quality, length, etc. of the recording. For example, the controller 720 may instruct device 10 to increase the sample interval time length. Likewise, the controller 720 may instruct the device(s) 10 to decrease the sample time, if an average sample length provides music data that is overly longer than that required to make a match.

Another aspect of the device controller 720 may include controlling the time of day that the device(s) 10 are operable. Initially, each device may be set to record sample interval data 30 and send the data to system 130. Over time, the artificial intelligence and/machine learning capabilities of module 800 may determine the packet data 20 does not include musical data during certain periods of time. For example, at bars and night clubs, the sample interval data 30 may only include musical data during the evening hours. As a result, the controller 720 would communicate to the corresponding device 10 and limit that device 10 to recording sample interval data 30 to only the evening hours. When controller 720 performs this action, the controller 720 may simultaneously notify the owner or appropriate venue personnel of the change.

In the case that the device 10 owner or appropriate venue personnel entered limited recording hours (i.e., less than 24 hours/day) into the GUI 430 and module 800 determines that there is consistently sample interval data 30 at the beginning and end of the specified recording hours, the controller will instruct the corresponding device 10 to increase the daily recording time period.

The song match publication server or module 800 is configured to match the sample interval data 30 received from a source venue 200 to a known musical composition and publish the known musical composition and source venue 200 location to client device(s) 220. The module 800 includes a data quality unit 810, sample interval data match unit 820, venue location match unit 830, and a venue song title/publication unit 840. The match publication module 800 receives at least one data packet 20 from the device server 700. Although the processing of one data packet 20 is discussed, module 800 may continually receive data packets 20 including sample interval data 30 from multiple devices 10 and venues 200.

Module 800 provides data packet 20 to the sample interval match unit 820 which is configured to match the sample interval data 30 to a known music composition. Initially, unit 820 may enhance data 30 in the recognition unit 825 to clean the audio data by removing data artifacts such as non-musical data components, recording interference, etc. The enhancement of data 30 will provide a more optimum match.

Unit 820 communicates with the known music server 600 to match the sample interval data 30 to known music or songs and may use methods known in the art such as fingerprinting to establish the match of the data 30 with a known music composition. As discussed in Wang et al., U.S. Publication No. 2012/0191231 (Jayne, I don't think this is correct), entitled “Methods and Systems For Identifying Content In Data Stream By A Client Device”, which is herein incorporated by reference in its entirety, various content identification techniques are known in the art for performing computational content identifications of media samples and features of media samples using a database of song or media tracks.

Using data matching techniques, unit 820 may produce a match data set including the data packet 20 and a song title that matches the sample interval data 30 incorporated into the data packet 20. Alternatively, if unit 820 is not able to make a match, unit 820 produces an unmatched data packet 20 or a data packet tagged in some way to indicate that no match has been made.

The venue match unit 830 receives the match data set from unit 820. In the case that the venue physical address 28 is not included in the data packet 20, unit 820 identifies the hashed ID 40 from the data packet 20. Next, unit 830 accesses the location/device database 420 to look up the venue physical address 28. The venue match unit 830, then, produces a venue song match data set including the data packet 20 and a song title that matches the sample interval data 30 and the venue 200 that the sample interval data 30 was recorded. If applicable, the venue match data set will also include the additional venue location data 29 that specifies a location within a venue 200.

Module 800 stores each venue song match data set in matched database 900 and provides a historical GUI 860, as shown in FIG. 6 for access by 3^{rd} party 160 client servers, which may correspond to artists and recording studios as well as client devices 220 which may correspond to individual users. The historical database GUI 860 includes a search box that allows a user to designate a search 865 by time period, date, geographic location, venue, and song title, etc., and provides corresponding results. The search may be performed by techniques known in the art. As a result, as shown in FIG. 6, the historical database GUI 860 may provide the date & time and venue that a song title was played during a requested time period.

Also, module 800 provides each venue song match data set to the venue song title/publication unit 840 which publishes the venue 200 and song match in real time to each client GUI stored in database 520. The publication may be provided in various formats. For example, notifications (i.e., text. SMS or emails, etc.) may be sent client GUI in database 520. Unit 840 may generate GUI 850 on client devices 220.

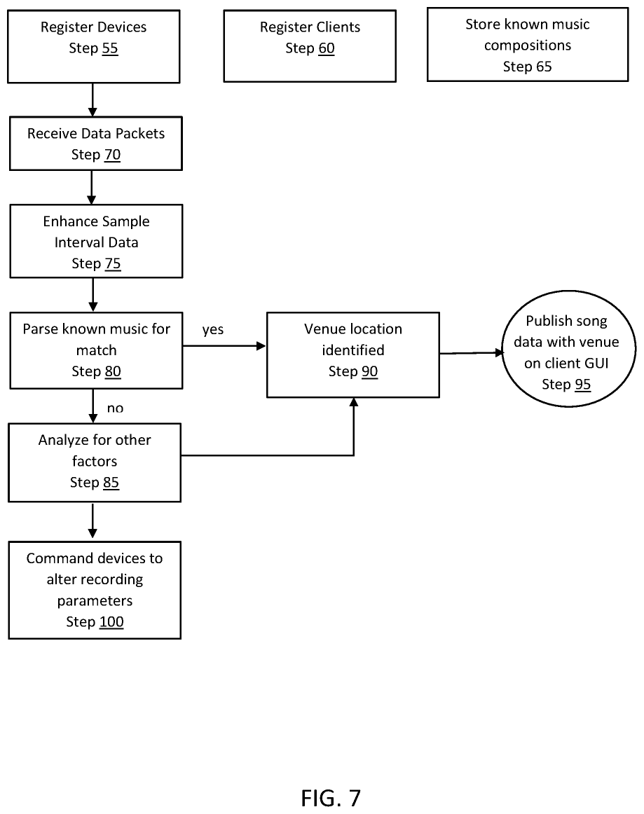

FIG. 7 depicts method 50 for publishing songs played at a venue. Initially in step 55, device 10 is registered with system 130, as described above, by the venue server 400.

In step 60, the client server 500 registers, as described above, the client devices 220 with system 130. It is noted that the client device(s) 220 may be remote, proximal or inside the venue 200. The client server 500 stores all the relevant client data in the client database.

In step 65, the known music server 600 collects known music compositions using the artist interface 610 and/or known music interface. Server 600 stores the known music compositions in the known music database 640.

In step 70, the device server 700 receives data packets 20 from the registered devices 10. Server 700 stores the data packets 20 in the sample interval database 710 and transmits the data packet 20 to the song match module 800.

Step 75 is the first step of matching the sample interval data 30 in the data packets 20 to known music compositions. The data packet 20 is received by module 800 and transferred to the sample interval match unit 820. Initially, the recognition unit 825 may read the sample interval data 30 of the packet and perform data enhancement steps such as removing non-musical data and artifacts. Next, unit 820 may establish a data profile or unknown fingerprint for use in the matching process.

In step 80, the sample interval match unit 825 parses the known music database 640 and/or large music repositories to match the fingerprint to a known musical composition. If a match is made, then unit 825 sends a match data set, including the data packet 20 and known musical composition to the venue location match unit 830.

In step 85, if no match can be made, the sample interval match unit 820 analyzes the sample interval data 30 for beats per minute (bpm) to determine other factors such as a genre and/or live performance or not. If any determination as to genre and live or recorded performance is ascertained, this determined data is coupled with the data packet 20 sent the data quality unit 810 and venue location unit 830.

In step 90, the venue location match unit 830 ascertains which venue 200 the matched and unmatched dataset correspond. Unit 830 reads the hashed ID 40 in the data packets 20 and parses the location/device database 420 to match the hash ID 40 to the corresponding device 10 and venue 200 from which the data packet 20 was received. Next, unit 830 creates a venue song match data set including the title of the song, venue name, physical location of the venue, artist, etc.

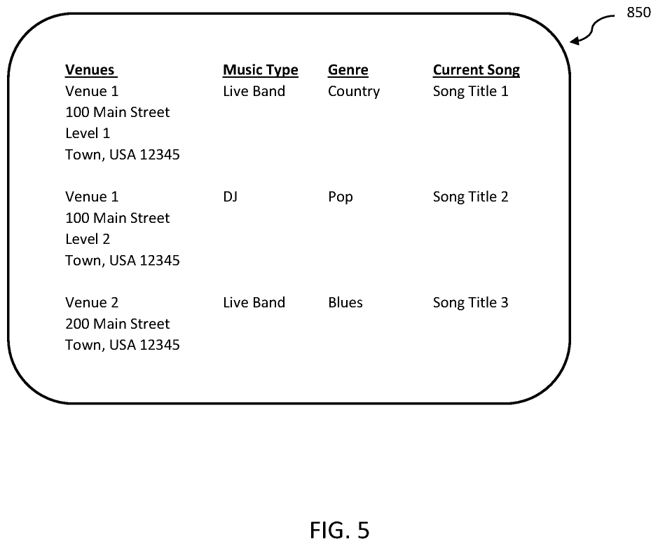

In step 95, the venue/song publication unit 840 publishes the venue song match data set to client GUI 850. An example of the data appearing in the client GUI 850 is provided in FIG. 5. It is noted that the data presented in GUI 850 may also include time of recording, genre and live or recorded performance.

In step 100, the data quality unit 810 receives the unmatched data packet 20 and analyzes or detects the quality level. Based on the quality level, unit 810 provides commands to the device controller 720 to take actions to increase the quality level of the sample interval data recording. Unit 810 identifies device 10, via the hashed ID 40, from which the unmatched data packet 20 was received. Next, controller 720 may instruct device 10 to alter the microphone from which the audio data is recorded, increase the time length of the same interval, decrease the time length of the non-recording interval or any combination thereof. Further, controller 720 sends a notification to the device owners GUI regarding the poor data quality of the sample interval data 30.

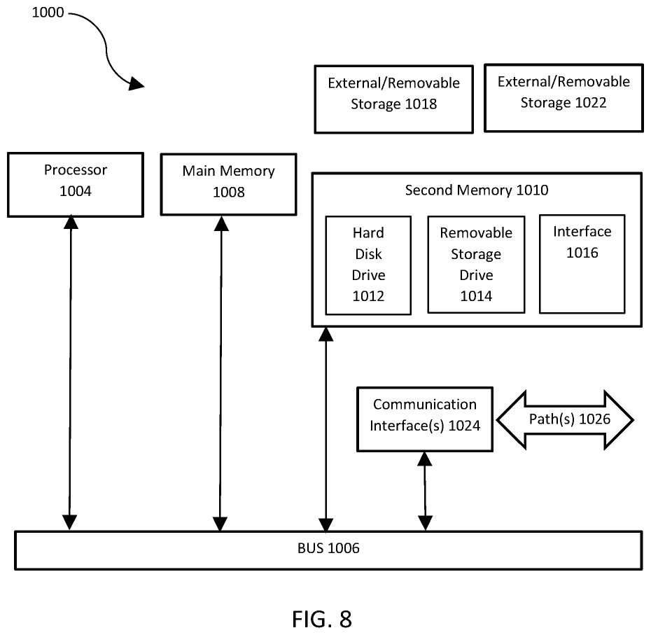

Embodiments shown in FIGS. 1-7, or any part(s) or function(s) thereof, may be implemented using hardware, software modules, firmware, cellular phones/devices, devices 10, tangible computer readable media having instructions stored thereon, or a combination thereof and may be implemented in one or more computer systems, networks or other processing systems. FIG. 8 illustrates an example computer system 1000 in which embodiments, or portions thereof, may be implemented as computer-readable code. For example, the song location publication system 130, the client devices 220, devices 10, owner/venue devices 170, match publication module 800 as well as any of the modules and databases depicted in FIGS. 1 and 2, can be implemented in computer system 1000 using hardware, software, firmware, tangible computer readable media having instructions stored thereon, or a combination thereof and may be implemented in one or more computer systems or other processing systems. Hardware, software, or any combination of such may embody any of the modules and components in FIGS. 1-7.

If programmable logic is used, such logic may be executed on a commercially available processing platform or a special purpose device. One of ordinary skill in the art may appreciate that embodiments of the disclosed subject matter can be practiced with various computer system configurations, including multi-core multiprocessor systems, minicomputers, mainframe computers, computer linked or clustered with distributed functions, as well as pervasive or miniature computers that may be embedded into virtually any device (i.e., devices 10, smart phones, laptops and tablets, etc.). For instance, at least one processor device and a memory may be used to implement the above-described embodiments. A processor device may be a single processor, a plurality of processors, or combinations thereof. Processor devices may have one or more processor “cores.”

Various embodiments of the invention are described in terms of this example computer system 1000. After reading this description, it will become apparent to a person skilled in the relevant art how to implement embodiments of the present invention using other computer systems and/or computer architectures. Although operations may be described as a sequential process, some of the operations may in fact be performed in parallel, concurrently, and/or in a distributed environment, and with program code stored locally or remotely for access by single or multi-processor machines. In addition, in some embodiments the order of operations may be rearranged without departing from the spirit of the disclosed subject matter.

Processor device 1004 may be a special purpose, a general purpose processor device artificial intelligence processor or any combination thereof. As will be appreciated by persons skilled in the relevant art, processor device 1004 may also be a single processor in a multi-core/multiprocessor system, such system operating alone, or in a cluster of computing devices operating in a cluster or server form. Processor device 1004 is connected to a communication infrastructure 1006, for example, a bus, message queue, network, or multi-core message-passing scheme.

Computer system 1000 also includes a main memory 1008, for example, transitory or random access memory (RAM), and may also include a non-transitory secondary memory 1010. Secondary memory 1010 may include, for example, a hard disk drive 1012, removable storage drive 1014. As will be appreciated by persons skilled in the relevant art, removable storage unit 1018 includes a computer usable storage medium having stored therein computer software and/or data. Also, a non-transitory machine-readable medium, such as secondary memory 1010, may contain a set of executable instructions to facilitate the steps of method 50.

In alternative implementations, secondary memory 1010 may include other similar means for allowing computer programs or other instructions to be loaded into computer system 1000. Such means may include, for example, a removable storage unit 1022 and an interface 1020. Examples of such means may include a program cartridge and cartridge interface (such as that found in video game devices), a removable memory chip (such as an EPROM, or PROM, USB Drive) and associated socket, and other removable storage units 1022 and interfaces 1016 which allow software and data to be transferred from the removable storage unit 1022 to computer system 1000.

Computer system 1000 may also include a communications interface 1024. Communications interface 1024 allows software and data to be transferred between computer system 1000 and external devices. Communications interface 1024 may include a modem, a network interface (such as an Ethernet card), Wi-Fi, a communications port, a PCMCIA slot and card, or the like. Software and data transferred via communications interface 1024 may be in the form of signals, which may be electronic, electromagnetic, optical, or other signals capable of being received by communications interface 1024. These signals may be provided to communications interface 1024 via a communications path 1026. Communications path 1026 carries signals and may be implemented using wire or cable, fiber optics, a phone line, a cellular phone link, an RF link or other communications channels. The communications interface 1024 may include API server 450 and web server 460.

In this document, the terms “computer program medium” and “computer usable medium” are used to generally refer to media such as removable storage unit 1018, removable storage unit 1022, and a hard disk installed in hard disk drive 1012. Computer program medium and computer usable medium may also refer to memories, such as main memory 1008 and secondary memory 1010, which may be memory semiconductors (e.g. DRAMs, etc.).

Computer programs (also called computer control logic) are stored in main memory 1008 and/or secondary memory 1010. Computer programs may also be received via communications interface 1024. Such computer programs, when executed, enable computer system 1000 to implement embodiments as discussed herein. In particular, the computer programs, when executed, enable processor device 1004 to implement the processes of embodiments of the present invention, such as the stages in the methods illustrated by flowchart of FIG. 7, discussed above. Accordingly, such computer programs represent controllers of the computer system 1000. Where embodiments are implemented using software, the software may be stored in a computer program product and loaded into computer module 800 using removable storage drive 1014, interface 1020, and hard disk drive 1012, or communications interface 1024.

Embodiments of the invention also may be directed to computer program products comprising software stored on any computer useable medium. Such software, when executed in one or more data processing devices, causes a data processing device(s) to operate as described herein. Embodiments of the invention employ any computer useable or readable medium. Examples of computer useable mediums include, but are not limited to, primary storage devices (e.g., any type of random access memory), secondary storage devices (e.g., hard drives, floppy disks, CD ROMS, ZIP disks, tapes, magnetic storage devices, and optical storage devices, MEMS, nano-technological storage device, etc.), and communication mediums (e.g., wired and wireless communications networks, local area networks, wide area networks, intranets, etc.).

Exemplary embodiments of the present invention have been presented. The invention is not limited to these examples. These examples are presented herein for purposes of illustration, and not limitation. Alternatives (including equivalents, extensions, variations, deviations, etc., of those described herein) will be apparent to persons skilled in the relevant art(s) based on the teachings contained herein. Such alternatives fall within the scope and spirit of the invention.

Embodiments have been described above with the aid of functional building blocks illustrating the implementation of specified functions and relationships thereof. The boundaries of these functional building blocks have been arbitrarily defined herein for the convenience of the description. Alternate boundaries can be defined so long as the specified functions and relationships thereof are appropriately performed.

The breadth and scope of the present invention should not be limited by any of the above-described exemplary embodiments but should be defined only in accordance with the following claims and their equivalents.

If system 130 attempts to process the audio sample and cannot determine the music or audio sample type against any known database, the server may process the sample to determine other information such as beats per minute (bpm), what genre the song may be, instruments included in the audio sample, and if the music is performed live.

It will be appreciated by those skilled in the art that changes could be made to the embodiments described above without departing from the broad inventive concept thereof. It is understood, therefore, that this invention is not limited to the particular embodiments disclosed, but it is intended to cover modifications within the spirit and scope of the present invention as generally defined in the appended claims.

1. A music location publication system comprising:
at least one computer processor or plurality of computer processors and non-transitory memory;
a song location publication module executable by said at least one computer processor or said plurality of computer processors, the song location publication module configured to receive sound interval data representing a time length of a portion of a music stream at a venue and a physical location corresponding to the venue, the song location publication module including
a location database in the non-transitory memory, the location database configured to store the physical location of the venue,
a sample interval match unit executable by said at least one computer processor or said plurality of computer processors, the sample interval match unit configured to match the sound interval data to a known musical composition and a title, and
a venue location match unit executable by said at least one computer processor or said plurality of computer processors, the venue location match unit configured to generate a data set including the title matched with the venue or the physical location of the venue; and
at least one client graphical user interface connected to said at least one computer processor or said plurality of computer processors, the at least one client graphical user interface configured to display the data set.

2. The system of claim 1, wherein the at least one client graphical user interface is located at the venue.

3. The system of claim 1, wherein the at least one client graphical user interface is located at a remote location outside of the venue.

4. The system of claim 1, wherein the at least one client graphical user interface is a plurality of client graphical user interfaces including a first client graphical user interface positioned at the venue and a second client graphical user interface positioned at a remote location outside if the venue.

5. The system of claim 1, further comprising:
a match database in the non-transitory memory, the match database including the data set of the title matched with the venue or the physical location of the venue.

6. The system of claim 5, further comprising:
at least one user graphical user interface connected to said at least one computer processor or said plurality of computer processors, the at least one user graphical user interface configured to receive search instructions for a first title and display a first venue or a first location where the first title was played.

7. The system of claim 1, wherein the song location publication module further comprises:
a data quality unit executable by said at least one computer processor or said plurality of computer processors, the data quality unit configured to determine a quality level corresponding to the sound interval data.

8. The system of claim 7, further comprising:
a sound recording device at the venue, the sound recording device configured to transmit the sound interval data to the song location publication module; and
a device graphical user interface connected to said at least one computer processor or said plurality of computer processors, the device graphical user interface configured to display information corresponding to the sound recording device and the sound interval data.

9. The system of claim 8, further comprising:
a device controller executable by said at least one computer processor or said plurality of computer processors, the device controller configured to receive, from the data quality unit, the quality level of the sound interval data and display, on the device graphical user interface, the quality level of the sound interval data.

10. The system of claim 8, further comprising:
a device controller executable by said at least one computer processor or said plurality of computer processors, the device controller configured to receive the quality level of from the data quality unit and based on the quality level, instruct the sound recording device to change the time length of recording the sound interval data.

11. The system of claim 8, wherein the sound recording device includes a first microphone and a second microphone and the sound recording device is recording the sound interval data with the first microphone, further comprising:
a device controller executable by said at least one computer processor or said plurality of computer processors, the device controller configured to receive the quality level from the data quality unit and when the quality level is insufficient, instruct the sound recording device to use the second microphone to record the sound interval data.

12. The system of claim 1, further comprising:
a sound recording device at the venue, the sound recording device configured to transmit the sound interval data to the song location publication module; and
a device controller executable by said at least one computer processor or said plurality of computer processors, the device controller configured to instruct the sound recording device to transmit the sound interval data, for the time length, to the song location publication module and the device controller configured to instruct the sound recording device not to transmit the sound interval data to the song location publication module for a another time length such that the time length and another time length continually repeat in an alternating pattern.

13. The system of claim 1, further comprising:
a sample interval data receiver executable by said at least one computer processor or said plurality of computer processors, the sample interval data receiver configured to receive the sound interval data for the time length, and the sample interval data receiver configured, for an another time length, not to receive any sound data from the music stream such that the time length and the another time length continually repeat.

14. A method of publishing songs played at a venue, the method comprising steps of:
providing at least one computer processor or plurality of computer processors including a communication interface and non-transitory memory;
receiving, via the communication interface, sound interval data from at least one physical address, the sound interval data having a time length corresponding to a portion of an audible music stream;
storing a venue location database in the non-transitory memory, the venue location database including a plurality of physical addresses from which the sound interval data is received;
using a song match publication module that is executable on said at least one computer processor or said plurality of computer processors to match the sound interval data to a known music composition and identify a corresponding physical address of the plurality of physical addresses from which the sound interval data was received; and
displaying on at least one client graphical user interface connected, via the communication interface, to the song match publication module, the known music composition and the corresponding physical address of the plurality of physical addresses.

15. The method of claim 14, wherein the step of receiving, via the communication interface, the sound interval data from the at least one physical address further comprises steps of:
receiving a data packet including the sound interval data and the corresponding physical address or a location tag from which the data packet was received.

16. The method of claim 15, wherein the step of storing the venue location database in the non-transitory memory, further comprises steps of:
storing a plurality of location tags in the venue location database, wherein each location tag of the plurality of location tags corresponds to one physical address of the plurality of physical addresses stored in the venue location database.

17. The method of claim 16, further comprising the steps of:
matching the location tag of the data packet with the one physical address of the plurality of physical addresses.

18. The method of claim 14, further comprising the steps of:
providing a device controller that is executable on said at least one computer processor or said plurality of computer processors, the device controller in communication with a sound interval recording device at the venue from which the sound interval data is received; and
sending instructions from the device controller to the sound interval recording device to increase or decrease the time length of recording the sound interval data.

19. The method of claim 18, further comprising steps of:
detecting, through use of the song match publication module, a quality of the sound interval data; and
instructing, based on the quality of the sound interval data, the sound interval recording device to increase or decrease the time length of recording the sound interval data.

20. The method of claim 14, further comprising the steps of:
detecting, through use of the song match publication module, a quality of the sound interval data as being insufficient; and
displaying on a user graphical interface corresponding to a sound recording device from the sound interval data was received, a notification of insufficient signal quality.

21. The method of claim 14, further comprising the steps of:
detecting, through use of the song match publication module, a quality of the sound interval data as insufficient; and
displaying on a user graphical interface corresponding to a sound recording device from which the sound interval data was received, a notification of insufficient signal quality.

22. The method of claim 15, further comprising a step of:
providing sound recording device connected, via the communications interface, to the song match publication module.

23. The method of claim 22, further comprising the step of:
providing a user graphical interface in communication with the sound recording device and the song match publication module; and
receiving, via the user graphical interface, the physical address of the venue from which the sound interval data is received.

24. A non-transitory machine-readable medium containing a set of executable instructions to facilitate a method of publishing songs played at a venue, the method comprising steps of:
receiving sound interval data from at least one venue, the sound interval data having a time length corresponding to a portion of an audible music stream;
storing a venue location database in a non-transitory memory such that the venue location database includes a plurality of venues from which the sound interval data is received and a plurality of venue physical addresses, wherein each venue of the plurality of venues is matched with a corresponding venue physical address of the plurality of venue physical addresses;
using a song match publication module to match the sound interval data to a known music composition and identify the venue physical address of plurality the venue physical addresses from which the sound interval data was received; and
displaying on at least one client graphical user interface connected, via a communication interface, to the song match publication module, the known music composition and physical location address of the venue from which the sound interval data was received.
